(19) United States
(12) Patent Application Publication
(10) Pub. No.: US 2005/0053282 A1
(43) Pub. Date: Mar. 10, 2005

(54) Apparatus and method for character recognition and program thereof

(75) Inventors: Ching Y. Suen, Quebec (CA); Hiroyuki Hase, Fukui (JP); Hiroshi Kakutani, Ishikawa (JP)

Correspondence Address: STAAS & HALSEY LLP, SUITE 700, 1201 NEW YORK AVENUE, N.W., WASHINGTON, DC, 20005, US

(73) Assignees: Japan as represented by The President of University of Fukui, Fukui (JP); PFU Limited, Ishikawa (JP)

(21) Appl. No.: 10/786,083

(22) Filed: Feb. 26, 2004

(30) Foreign Application Priority Data
Sep. 5, 2003 (JP) 2003-313367

(51) Int. Cl. G06K 9/34

(52) U.S. Cl. 382/182

(57) ABSTRACT

A character recognition apparatus has space storage to store Eigen spaces made from a plurality of rotated character images, loci storage to store loci drawn for projection points obtained by projecting the plurality of rotated character images in corresponding Eigen spaces; an input unit to input the recognition target images; a distance calculation unit to obtain distances between projection points obtained by projecting the recognition target images in Eigen space and respective loci for the plurality of character types, and a candidate selection unit to select candidates for images for recognition target characters from the plurality of character types based on the distance.

### BACKGROUND OF THE INVENTION

1. Field of the Invention

This invention relates to an apparatus and method for character recognition and program thereof, and particularly relates to an apparatus and method for character recognition and program thereof for accurately recognizing characters regardless of rotation angle of rotated characters by applying Eigen space techniques.

2. Description of the Related Art

With printed matter such as catalogs etc., there are cases where characters are presented in a distorted manner, are inclined, rotated, or provided in a form that is in vogue (for example, characters that have been patterned, etc.) in order to draw people's attention to them. There are cases where such documents are read using a scanner and subjected to character recognition processing using a computer so as to obtain encoded electronic data for the characters.

For example, typically, bitmap data for images (patterns) of characters rotated by prescribed intervals (for example, ten degrees, twenty degrees, . . . ) are pre-stored as a dictionary for rotated characters so as to enable recognition by comparison of images (bitmaps) for read-in characters and each pattern of the dictionary using some kind of means (for example, Japanese Patent Application Laid-open No. 5-12491).

Further, up until now, several rotation-invariant character recognition methods have been proposed, with there being three main approaches. A first is a method of extracting invariant features for rotation (non-patent document #1: S. X. Liao and M.Pawlak, “On Image Analysis by Moments,” IEEE Trans. on PAMI,Vol.18,No.3,pp.254-266,(1996)). A second is a method of using neural networks (non-patent document #2: S. Satoh, S. Miyake and H. Aso, “Evaluation of Two Neocognitron-type Models for Recognition of Rotated Patterns,” ICONIP2000,WBP-04,pp.295-299(2000)). A third employs a plurality of templates. For example, Xie et. al propose an invariant system for rotation by preparing a plurality of reference patterns for different angles (non-patent document #3: Q. Xie, A. Kobayashi, “A Construction of Pattern Recognition System Invariant to Translation, Scale-change and Rotation Transformation of Patterns (in Japanese), “Trans. of The Society of Instrument and Control Engineers, Vol.27,No.10, pp.1167-1174(1991)). Further, a method of recognizing by estimating character order using mathematical models and normalizing the orientation of characters has also been considered (non-patent document #4: H. Hase, M. Yoneda, T. Shinokawa, C. Y. Suen, “Alignment of Free Layout Color Texts for Character Recognition,” Proceedings of the 6th International Conference on Document Analysis and Recognition, pp. 932-936 (Seatle, USA)).

Character recognition using a computer can be considered to be possible using writing character recognition techniques etc. for characters transformed to a certain extent. However, in reality, it is difficult to estimate inclination (or rotation) angle of characters that have been inclined or rotated and this kind of character recognition has generally been difficult by computer. An example of an inclined and rotated character string is shown in FIG. 18. With the exception of the example of FIG. 18A (an example printed normally), character recognition by computer is difficult for the examples FIG. 18B to FIG. 18D. In particular, character recognition is difficult for the example of FIG. 18C that is waving and the example of FIG. 18D where the angle of inclination changes substantially as the inclination of the characters changes.

Recognition of these characters by people capable of reading characters that are back-to-front or provided as a mirror image is extremely easy. This is because people can easily discern and discriminate the order and orientation of characters using their flexible cognitive powers. However, it is difficult for a computer to do the same thing. Further, it is difficult for a computer to find rules regarding arrangement and orientation of characters without performing character recognition.

For example, in methods employing the dictionaries described above, there is substantially no matching with the angle of inclination of characters recorded in the dictionary because the angle of inclination of read characters is arbitrary. Because of this, precision of character recognition falls, and it has not been possible to reliably estimate the angle in order to make the characters erect.

Further, with the rotation invariant character recognition methods described above, it has not been possible to obtain character recognition of satisfactory precision, with the range of application being extremely limited to the point that practical use has not been possible. For example, according to the non-patent document #3, recognition results of only 97% could only be obtained for ten types of (or a small number of) digits. Further, according to the non-patent document #4, character strings can not always be arranged as with this kind of mathematical model.

We therefore considers that this recognition rate can be increased when rotated characters are recognized by applying parametric Eigen space techniques (simply referred to as Eigen space techniques). Parametric Eigen space technology is technology originally relating to object recognition, and is shown in “Hiroshi Murase, “S. K. Nayar, three-dimensional object recognition using two-dimensional collation—parametric Eigen space techniques, IECE Trans. vol.J₇₇-D-II, no.11, pp. 2179-2187, November 1994.” According to study carried out by the inventors, in cases of applying these character recognition techniques to character recognition, it can be considered that there is provided predominance enabling the acquisition of inclination angle at the same time as recognition results (category).

### SUMMARY OF THE INVENTION

It is an object of the present invention to provide a character recognition apparatus capable of accurately recognizing characters regardless of an angle of rotation of rotated characters by applying Eigen space techniques.

It is a another object of the present invention to provide a character recognition method capable of accurately recognizing characters regardless of an angle of rotation of rotated characters by applying Eigen space techniques.

It is still another object of the present invention to provide a character recognition program capable of accurately recognizing characters regardless of an angle of rotation of rotated characters by applying Eigen space techniques.

A character recognition apparatus of the present invention comprises: space storage to store, for a plurality of types of characters, Eigen spaces made from a plurality of rotated character images obtained by rotating first character images for the character types through a plurality of angles; loci storage to store loci drawn for projection points obtained by projecting the plurality of rotated character images in the corresponding Eigen spaces for the plurality of character types; an input unit to input images for recognition target characters; a distance calculation unit to obtain distances for between projection points for the recognition target characters obtained by projecting images for the recognition target characters in Eigen space and each loci for the plurality of character types; and a candidate selection unit to select candidates for images for the recognition target characters from the plurality of character types.

A character recognition method of the present invention comprises: preparing, for a plurality of types of characters, Eigen spaces made from a plurality of rotated character images obtained by rotating first character images for the character types through a plurality of angles; preparing loci drawn for projection points obtained by projecting the plurality of rotated character images in the corresponding Eigen spaces for the plurality of character types; inputting images for recognition target characters; obtaining distances for between projection points for the recognition target characters obtained by projecting images for the recognition target characters in Eigen space and each loci for the plurality of character types; and selecting candidates for images for the recognition target characters from the plurality of character types.

A character recognition program of the present invention is for implementing a character recognition method for a character recognition apparatus on a computer. And the program causes the computer to execute: preparing, for a plurality of types of characters, Eigen spaces made from a plurality of rotated character images obtained by rotating first character images for the character types through a plurality of angles, and loci drawn for projection points obtained by projecting the plurality of rotated character images in the corresponding Eigen spaces; inputting images for recognition target characters; obtaining distances for between projection points for the recognition target characters obtained by projecting images for the recognition target characters in Eigen space and each loci for the plurality of character types; and selecting candidates for images for the recognition target characters from the plurality of character types.

According to the character recognition apparatus and method of the present invention, rotated characters are recognized by the application of Eigen space techniques. Namely, covariance matrix are calculated from a sufficient number of rotated character images and Eigen (sub) space is made for each character type (category). Next, a locus is obtained by projecting (and interpolating) the rotated character images in Eigen (sub) space. Unknown characters (recognition target characters) are then projected to Eigen (sub) space for each category, distance between projection points for the unknown character and the locus is calculated, and recognition is carried out based on this distance.

As a result, it is possible to obtain extremely high recognition results (for example, 99.89% in the case of the twenty-six characters of the alphabet) so as to satisfy in practical terms an extremely broad range without causing precision of the character recognition to be lowered even in cases where an angle of inclination of a character read in does not match with an angle of inclination of a registered character or in cases where the order in which read-in characters are lined up is irregular. It is also possible to accurately obtain the angle of inclination of the characters at the same time as the character recognition.

According to the character recognition program of the present invention, by storing this program on a medium such as a flexible disc, CD-ROM, CD-R/W, or DVD etc., or by providing the program through downloading via a network such as the Internet, etc., it is possible for the character recognition apparatus and method described above to be implemented in a straightforward manner so as to enable accurate character recognition.

### BRIEF DESCRIPTION OF THE DRAWINGS

FIG. 1 is a view showing a structure for a character recognition apparatus.

FIG. 2 is a view illustrating character recognition processing.

FIG. 3 is a further view illustrating character recognition processing.

FIG. 4 is another view illustrating character recognition processing.

FIG. 5 is a view illustrating character recognition processing.

FIG. 6 is a flowchart illustrating character recognition processing.

FIG. 7 is a view illustrating character recognition processing.

FIG. 8 is a further view illustrating character recognition processing.

FIG. 9 is another view illustrating character recognition processing.

FIG. 10 is a view illustrating character recognition processing.

FIG. 11 is a further view illustrating character recognition processing.

FIG. 12 is another further view illustrating character recognition processing.

FIG. 13 is a still further view illustrating character recognition processing.

FIG. 14 is a further view illustrating character recognition processing.

FIG. 15 is another view illustrating character recognition processing.

FIG. 16 is a further view illustrating character recognition processing.

FIG. 17 is a still further view illustrating character recognition processing.

FIG. 18 is a view showing the background of the present invention, and in particular, FIG. 18A to FIG. 18D show examples of inclined and rotated character strings.

### DETAILED DESCRIPTION OF THE PREFERRED EMBODIMENTS

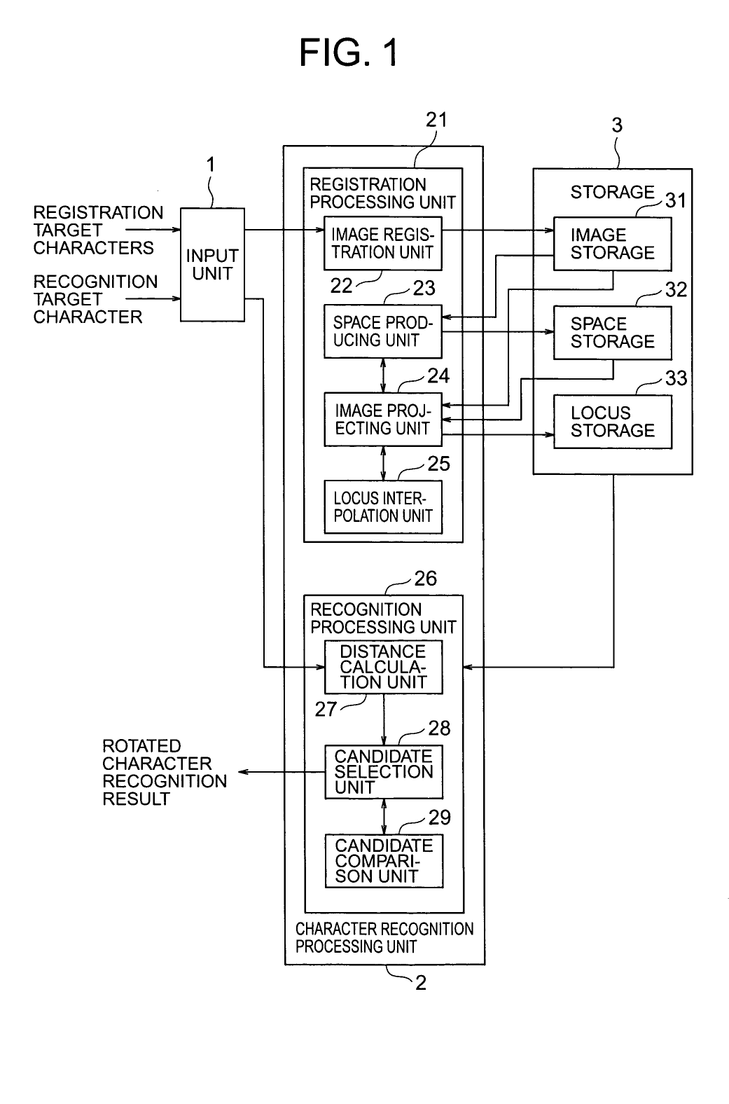

FIG. 1 is a view of a structure for a character recognition apparatus, and shows a structure for a character recognition apparatus of the present invention. The character recognition apparatus has an input unit 1, a character recognition processing unit 2, and storage (storage unit) 3. The character recognition processing unit 2 has a registration processing unit 21 and a recognition processing unit 26. The storage 3 has an image storage (image storage unit) 31, a space storage (space storage unit) 32, and a locus storage (locus storage unit) 33.

The input unit 1 comprises, for example, an image reading apparatus such as a well-known scanner etc., and inputs an image (bitmap data) for (one or more) characters read as a registration target or recognition target to the character recognition processing unit 2. Namely, the input unit 1 inputs characters for registration targets into (an image registration unit 22 of) the registration processing unit 21 and inputs characters for recognition targets to (a distance calculation unit 27) of the recognition processing unit 26.

The character recognition processing unit 2 (registration processing unit 21 and recognition processing unit 26) is a computer (body), and has a CPU and a main memory, and is realized by a program for carrying out registration processing and recognition processing in a main memory being executed on a CPU.

The character recognition processing unit 2 creates, in the registration processing unit 21, the image storage 31, space storage 32 and locus storage 33 constituting the dictionary used in character recognition processing of the present invention, by using characters for registration targets inputted from the input unit 1, and these are registered at the storage 3. The registration processing unit 21 has an image registration unit 22, space producing unit 23, image projecting unit 24, and locus interpolation unit 25.

The registration processing unit 21 may be omitted. Namely, rather than making the image storage 31, space storage 32, and locus storage 33 constituting a dictionary using the registration processing unit 21, a dictionary may also be prepared by registering a dictionary stored on a medium such as a separate, pre-made flexible disc, CD-ROM, CD-R/W, or DVD etc. in the storage 3. It is also possible for the character recognition processing unit 2 to download the image storage 31, space storage 32, and locus storage 33 constituting a dictionary made by a registration processing unit 21 provided at another computer via a network such as the Internet for storage in the storage 3.

The character recognition processing unit 2 then executes character recognition processing of the present invention using space storage 32 and locus storage 33 constituting a dictionary for characters for the recognition targets inputted from the input unit 1 at the recognition processing unit 26 and outputs recognition results. The recognition processing unit 26 has a distance calculation unit 27, a candidate selection unit 28, and a candidate comparison unit 29.

When a character for the registration target (for example, character “A”) is inputted from the input unit 1, the image registration unit 22 recognizes the image, and the character (image) are rotated at prescribed intervals (for example, ten degrees) through 360 degrees. As a result, the image registration unit 22 makes a plurality of rotated character images for the character. The image registration unit 22 makes a plurality of rotated character images for a plurality of types of character (for example, the 26 types of character of the alphabet). The process of recognizing and rotating this image and creating a plurality of rotated character images may be carried out, for example, by the input unit 1. The image registration unit 22 stores the plurality of rotated character images made for the plurality of types of characters in the image storage 31.

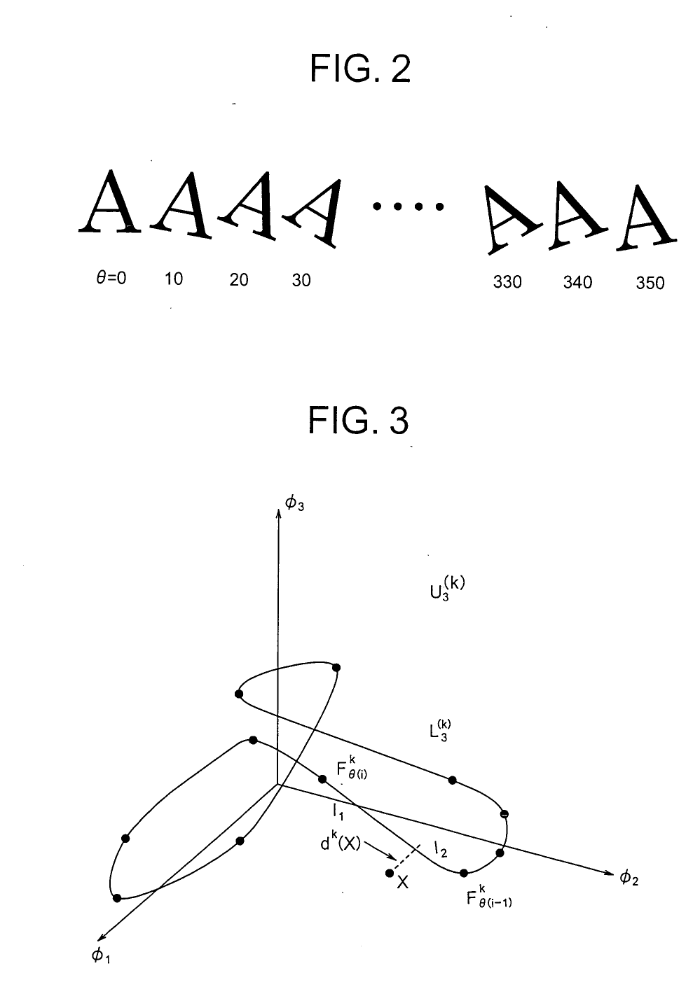

For example, as shown in FIG. 2, one character image (one image for the font Century) for a character type “A” is rotated by ten degrees at a time in a clockwise direction (or anticlockwise direction) so as to prepare 36 characters (rotated character images). In this way, all directions, i.e. 360 degrees are covered as angles of rotation. These rotated character images can then be used as learning characters (learning samples). A rotated character image is taken to be

$${f}_{θ ( i )}^{k} ,$$

where k is a category (i.e. type of character (character type)) number (or category subscript) from 1 to C, and θ(i) is an inclination angle for a character, and θ(i)=10×i (i=0,1,2, . . . , 35).

Each of the rotated character images are, for example, of sizes of 32×32 pixels (=1024 pixels), and all of the images are normalized. The values of the pixels are “0” or “1”. The rotated character image data can therefore be described as a 1024-dimensional vectors.

The image storage 31 stores a plurality of rotated character images obtained by rotating a single character image (for example, one image for the font Century for the character type “A”) for the character type through a plurality of angles for a plurality of character types. Specifically, the image storage 31 stores thirty-six rotated images (rotated by 0 degrees, 10 degrees, 20 degrees, . . . ) obtained by rotating the character through ten degrees at a time for a plurality of types of characters. As described in the following, the rotated character image is a learning sample (or learning character) for obtaining (learning) a locus depicting projection points for a rotated character obtained by projection in Eigen space. The angle of rotation is not limited to 10 degrees, although a common divisor of “360” is preferable. Namely, the number of learning samples is not limited to 36 per one character.

The space producing unit 23 calculates a covariance matrix using the plurality of rotated character images stored in the image storage 31 and calculates Eigen vectors corresponding to Eigen values. The space producing unit 23 then arranges Eigen vectors obtained in this manner in order of magnitude of Eigen value. Namely, Eigen space is made and stored in the space storage 32. The Eigen space is made for each plurality of character types.

The space storage 32 stores Eigen spaces made by the space producing unit 23 for each plurality of character types. Namely, the space storage 32 stores Eigen spaces made from a plurality of rotated character imaged obtained by rotating one character image for the character type through a plurality of angles for the plurality of character types.

The image projecting unit 24 then projects each of the plurality of rotated character images (learning samples) stored in the image storage 31 in Eigen (sub) space corresponding to the learning samples stored in the space storage 32. One projection point occurring in Eigen space is obtained from one learning sample. The projection point obtains a unique value for the learning sample. As a result of this, the image projecting unit 24 obtains a locus comprised of the projection points for the characters in the Eigen space (or drawn for the projection points). The image projecting unit 24 makes loci drawn for the Eigen values of the characters for a plurality of types of character and stores these in the locus storage 33. A locus drawn for projection points displays a unique shape (having a plurality of dimensions) for the character.

According to the example described above, Eigen space is made using (image data for) 36 rotated character images for each category (character type). A covariance matrix Σ^{(k)}(=1024×1024) can then be calculated for each category using

$${\sum }^{( k )} = {E}_{i} [ ( {f}_{θ ( i )}^{k} - {m}^{k} ) {( {f}_{θ ( i )}^{k} - {m}^{k} )}^{t} ] , \qquad ( equation 1 )$$

where m^{k} is the mean vector (mean image) for a k-th category. The covariance matrix satisfies the following equation:
Σ^{(k)}φ=λφ (equation 2),
where category subscript k is omitted with respect to λ and φ.

In the case of this example, since the rank of this covariance matrix is a maximum of 35, an Eigen values, whose number is a maximum of 35, other than a zero therefore is obtained. Here, respective Eigen values are taken to be λ₁, λ₂ . . . , λ₃₅, and corresponding Eigen vectors are taken to be φ₁, φ₂, . . . , φₙ. First, an Eigen (sub) space Uₙ^{(k)}={φ₁, φ₂, . . . , φₙ} is formed initially using n (n≦35) Eigen vectors.

Next, projection points

$${F}_{θ ( i )}^{k} for {f}_{θ ( i )}^{k} ( i = 0 , 1 , ⋯ 35 )$$

which are projected on Uₙ^{(k)} is

$${U}_{n}^{{( k )}^{t}} ( {f}_{θ ( i )}^{k} - {m}^{k} ) .$$

Since the rotation angle changes successively as described above, a set

$$\{ {F}_{θ ( i )}^{k} \}$$

for the projection points therefore depicts a continuous locus.

FIG. 3 shows a schematic view of a locus Lₙ^{(k)}. In FIG. 3, n=3. Namely, the Eigen (sub) space is a three-dimensional Eigen subspace expressed using three Eigen vectors φ₁, φ₂, φ₃ for category k. Further, in FIG. 3, “•” is a projection point for a learning character, with a solid line linking these points forming the locus L₃^{(k)}. A dotted line (perpendicular line) connecting projection points X for an unknown character and the locus L₃^{(k)} expresses the shortest distance dₖ(X) therebetween. Distances between projection points for two learning characters existing on either side of points of intersection (or two interpolated points) of the perpendicular line and the locus L₃^{(k)} are l₁ and l₂ described in the following.

The locus storage 33 stores loci depicted for projection points obtained by projecting each of the plurality of rotated character images obtained by rotating one character image for a character type through a plurality of angles for the plurality of character types. Namely, loci depicted for projection points for each character of a registration target are prepared as a dictionary. The dictionary used directly in character recognition processing is the space storage 32 and the locus storage 33. At the storage 3, the space storage 32 and the locus storage 33 except for the image storage 31 is referred to by the recognition processing unit 26.

The locus interpolation unit 25 interpolates projection points for learning characters obtained by projecting each of the plurality or rotated character images (learning samples) in Eigen space for the plurality of types of characters. Namely, interpolation points are obtained. Specifically, the locus interpolation unit 25 interpolates projection points obtained by the image projecting unit 24 using spline interpolation employing well-known periodic splines. For example, the locus interpolation unit 25 interpolates 1000 points using a periodic spline from the 36 projection points for the characters obtained by projecting each of the 36 rotated character images in Eigen space. In this case, the image projecting unit 24 stores loci drawn between values (interpolated points) interpolated for projection points obtained by the locus interpolation unit 25 and projection points in the locus storage 33 for a plurality of types of characters. As a result, when a smooth locus cannot be drawn with only projection points for a learning sample, it is possible to obtain a smooth locus using the projection points and the interpolated values. Further, this locus can be expressed either as a whole or piecewise using a function without employing interpolation.

The locus interpolation unit 25 may be omitted. Namely, if the number of learning samples is taken to be, for example, 120 (intervals of three), or 180 (intervals of two), a comparatively smooth locus can be obtained. The locus interpolation unit 25 can also be omitted in this case.

When characters (for example, one character image for character type “A”) that are recognition targets are inputted from the input unit 1, the distance calculation unit 27 obtains projection points for the recognition target characters (unknown characters) by projecting the recognition target characters in Eigen space using the space storage 32 and the locus storage 33 constituting the dictionary. The distance calculation unit 27 obtains a distance for between the projection point for an unknown character and each locus for a plurality of character types (for example, alphabet character types). This distance is the length of the perpendicular line occurring in the case where a vertical line is drawn with respect to the locus from the projection point for the character. For example, when the plurality of characters is the alphabet, 26 distances are calculated. A character having the shortest distance from within these distances is then the character type for the recognition target.

Namely, the unknown character image data x to be processed is projected onto all of Uₙ^{(k)}(k=1, 2, . . . , C). The projection point X for x is given by

$$X = {U}_{n}^{{( k )}^{t}} ( x - {m}^{k} ) .$$

Collation with the dictionary (locus Lₙ^{(k)}) is carried out by searching for points for minimum distances between the projection point X and the locus Lₙ^{(k)} shown in FIG. 3. Here, when the minimum distance for the category k (character expressed using subscript k) is taken to be d^{k}(X), recognition results k* can be written as

$${k}^{*} = arg [ {min}_{k} \{ {d}^{k} ( x ) \} ] . \qquad ( equation 3 )$$

On the other hand, the rotation angle θ for an unknown character image (recognition target character) can be calculated using the two closest points (projection points or interpolated points for the learning characters) occurring on locus Lₙ^{(k)} closest to the projected point X. For example, in the example shown in FIG. 3, this angle θ^{k} is interpolated using two points of

$${F}_{θ ( i - 1 )}^{k} and {F}_{θ ( i )}^{k} .$$

Namely, θ^{k} is taken to be

$${θ}^{k} = \frac{{1}_{1}}{{1}_{1} + {1}_{2}} {θ}_{( i - 1 )} + \frac{{1}_{2}}{{1}_{1} + {1}_{2}} {θ}_{( i )} , \qquad ( equation 4 )$$

where l₁ and l₂ are lengths shown in FIG. 3.

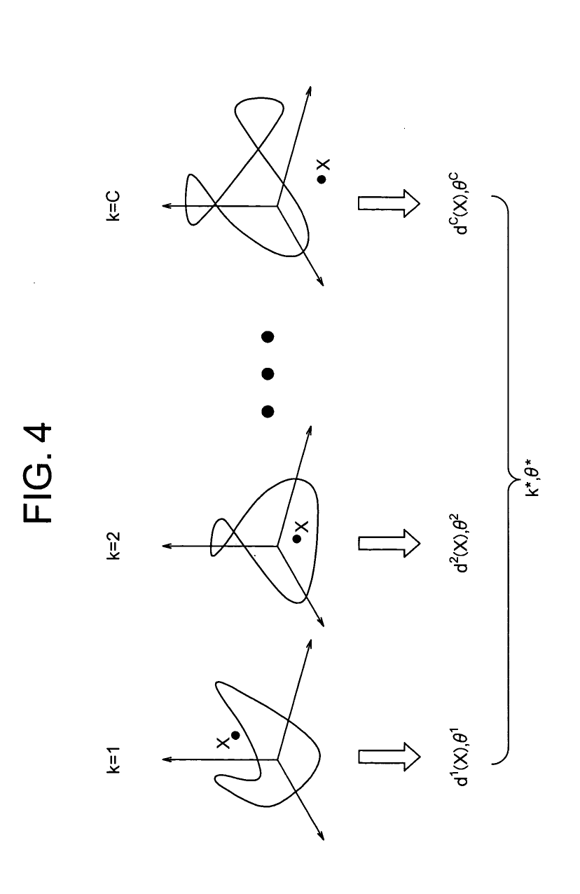

As shown above, according to the present invention, recognition results (character type, i.e. category k) for the input image (characters for the recognition target) and the rotation angle θ for the characters can be obtained at the same time. An outline view of the recognition method is shown in FIG. 4. In FIG. 4, the locus L₃⁽¹⁾ occurring in Eigen space for the character for the category k=1 is shown in the drawings. The unknown character x is projected in Eigen space, with this projection point being shown by X. At this time, distance d¹(X) between both parties and rotation angle θ¹ for the inputted image are obtained as described above. Similarly, distance d^{k}(X) and angle θ^{k} are obtained for each Eigen space for k=2 to C.

The candidate selection unit 28 selects candidates for (images for) recognition target characters from the plurality of character types based on calculated distances. Specifically, the candidate selection unit 28 selects just one character type for which the distance is calculated to be the shortest from the plurality of character types, and decides upon this as the character type (type of character) for the recognition target. Further, as described above, the candidate selection unit 28 decides upon the rotation angle of a recognition target character by using prescribed calculations employing projection points for the recognition target characters and the two neighboring points on the locus. For example, in the example shown in FIG. 4, the distance d¹(X) is taken to be the shortest, character type (for example, character type “A”) for the category k=1 is taken as the recognition target character (input image for unknown character), and rotation angle is taken to be θ¹.

According to the above structure, basically, it is possible for the character type and the rotation angle to be recognized with high precision for the recognition target character (unknown character). However, a candidate comparison unit 29 may be provided when it is wished to improve precision of character recognition corresponding to changes in character font and character transformations. In this case, the candidate selection unit 28 selects the plurality of characters from within the plurality of characters for which the distance calculated is the shortest, and decides upon this a candidate for the recognition target character. The candidate comparison unit 29 mutually compares (a plurality of) candidates selected by the candidate selection unit 28 and decides upon recognition target characters.

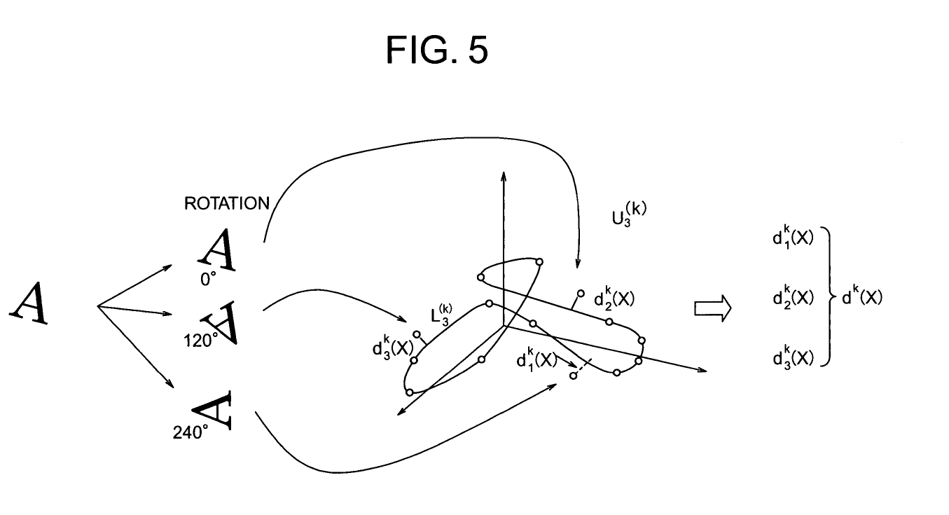

Specifically, as shown in FIG. 5, the candidate comparison unit 29 rotates the recognition target character (inputted character) by prescribed angles to obtain a plurality of rotated character images. For example, in FIG. 5, the inputted character type is “A” (but in reality is not known), and this is rotated 120 degrees at a time from a reference of 0 degrees (although in reality this is probably rotated). As a result, a three rotated character images are obtained in total. This processing may, in reality, be executed by the input unit 1 or by the image registration unit 22.

Next, the candidate comparison unit 29 projects the plurality of rotated character images in Eigen space corresponding to each of the plurality of candidates selected by the candidate selection unit 28 and obtains a plurality of projection points occurring in each of the Eigen spaces. For example, in FIG. 5, when a character type of category k is contained in the candidate, three rotated character images are projected to the Eigen space k. As a result, projection points for three rotated character images are obtained, and distances d₁^{k}(X), d₂^{k}(X) and d₃^{k}(X) are obtained for between the three projection points and the locus for the character type of category k (in random order). The same can also be the for other categories. This processing may, in reality, also be executed by the image projecting unit 24.

Next, the candidate comparison unit 29 takes the candidate of the candidates selected by the candidate selection unit 28 that is closest to the plurality of projection points as the character type for the recognition target character. For example, in FIG. 5, a mean value for the distances d₁^{k}(X), d₂^{k}(X) and d₃^{k}(X) is obtained and is taken as the distance d^{k}(X) between the recognition target character (unknown character) and the candidate. The same can also be for other categories (or other candidates). The candidate comparison unit 29 then takes the candidate within the candidates for which the mean distance is smallest as the character type of the recognition target character. Namely, a character type having a locus for which the plurality of distances are minimum is estimated to be the character type of the unknown character. As a result of this, this character recognition method is effective even if the character font is changed or character itself is transformed.

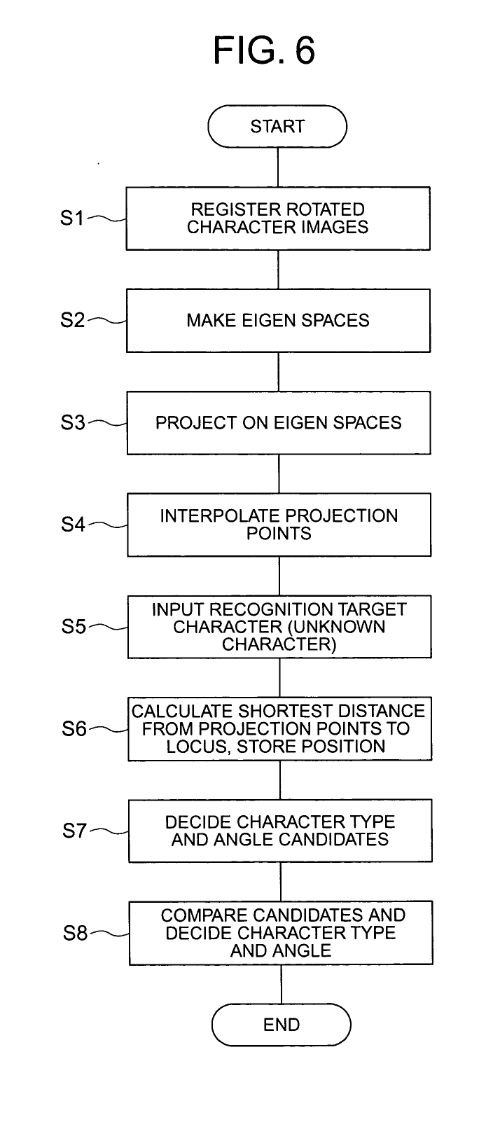

FIG. 6 is a character recognition processing flowchart, and shows character recognition processing for the character recognition processing apparatus shown in FIG. 1 of the present invention.

When the images for the registration target characters which were read by the input unit 1 are inputted to the image registration unit 22, the image registration unit 22 rotates the characters through a plurality of angles, makes a plurality of rotated character images (learning samples), and registers these in the image storage 31 (step S1). A plurality of rotated character images are then made and registered for each of the plurality of characters for the registration targets.

Next, the space producing unit 23 reads out the plurality of learning samples from the image storage 31 for each character type, and makes Eigen spaces (step S2). In this way, Eigen spaces are obtained for the candidate character types based on the plurality of learning samples for each of the plurality of character types for the registration targets.

Next, the image projecting unit 24 reads a plurality of learning samples from the image storage 31 for every character type and projects these to Eigen space (step S3). As a result, it is possible to obtain (a plurality of) corresponding projection points for the number of learning samples occurring in Eigen space for each of the plurality of character types for the registration targets, and a locus (polygonal line or rough locus) drawn for these is obtained.

Next, the locus interpolation unit 25 interpolates projected points obtained by the image projecting unit 24 for every character type using interpolation techniques such as periodic splines (step S4). As a result, values interpolated for the projection points obtained by the locus interpolation unit 25 are obtained, and as a result, a locus drawn for the interpolated values and the projection points can be obtained. The image projecting unit 24 then stores smooth loci obtained in this manner in the locus storage 33 for each of the plurality of characters for the registration targets.

Next, when images for the recognition target characters read in by the input unit 1 are inputted to the distance calculation unit 27 (step S5), the distance calculation unit 27 projects the recognition target characters (or unknown characters) in Eigen space so as to obtain projection points for the characters, and obtains distance (namely, a shortest distance occurring in Eigen space and a position thereof) for each of the loci for the plurality of character types from the projection points (step S6).

Next, the candidate selection unit 28 selects candidates for recognition target characters from the plurality of character types based on the calculated distances. Namely, the candidate selection unit 28 decides upon the character types and candidate angle (step S7).

Next, the candidate comparison unit 29 compares candidates and decides upon character type and angle, i.e. decides upon characters for recognition targets (step 8). Namely, the candidate comparison unit 29 rotates the recognition target characters by prescribed angles so as to obtain a plurality of rotated character images. As described above, this processing is executed by the image registration unit 22 and the input unit 1. Next, the candidate comparison unit 29 projects the plurality of rotated character images in Eigen spaces corresponding to the candidates selected by the candidate selection unit 28 and obtains a plurality of projection points. This processing may also be executed by the image projecting unit 24. Next, the candidate comparison unit 29 takes the candidate of the candidates selected by the candidate selection unit 28 that is closest to the plurality of projection points (for example, the candidate for which the mean distance is shortest) as the character type for the recognition target character.

### EXAMPLE 1

The twenty six capital letters (A, B, . . . , Z) of the English alphabet in the font Century are used as registration target characters (category). First, a 32×32 pixels character pattern for “0 degrees” is made for each category. Here, “0 degrees” describes a character in an upright state. Next, the character pattern for “0 degrees” is rotated, for example, “10 degrees” at a time so as to be re-sampled within a circumscribed region for the character image. As a result, 36 rotated character images with 32×32 pixels (learning samples) are made. The feature dimension at this time is 1024. The covariance matrix is obtained from these rotated characters, and Eigen values and Eigen vectors are calculated. The Eigen values and Eigen vectors may also be calculated by, for example, using mathematical software Mathematica (Stephen Wolfram, “Mathematica,” Wolfram Research,Inc.Vol.4(2000)).

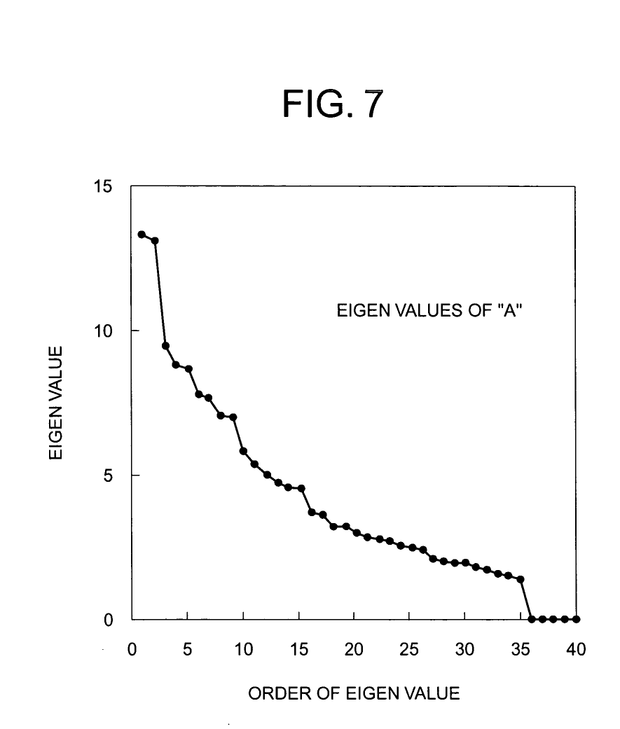

FIG. 7 shows an example of Eigen values for character “A”. It can be discerned that 35 Eigen values greater than “0” can be obtained. Eigen vectors are lined up in order of the Eigen values, and n-dimensional Eigen sub space is constructed by using the upper order n Eigen vectors. The value n is a sufficient number to have meaning (i.e. satisfy the demanded character recognition performance) with respect to character recognition. The value of n depends on the number of character types etc. taken as the range capable of recognition. The candidate selection unit 28 therefore projects each of the plurality of rotated character images in Eigen space of a number of dimensions sufficient for giving meaning with respect to character recognition. This means that effective character recognition is possible using fewer dimensions (or little computational complexity) for the character types taken as the recognizable range.

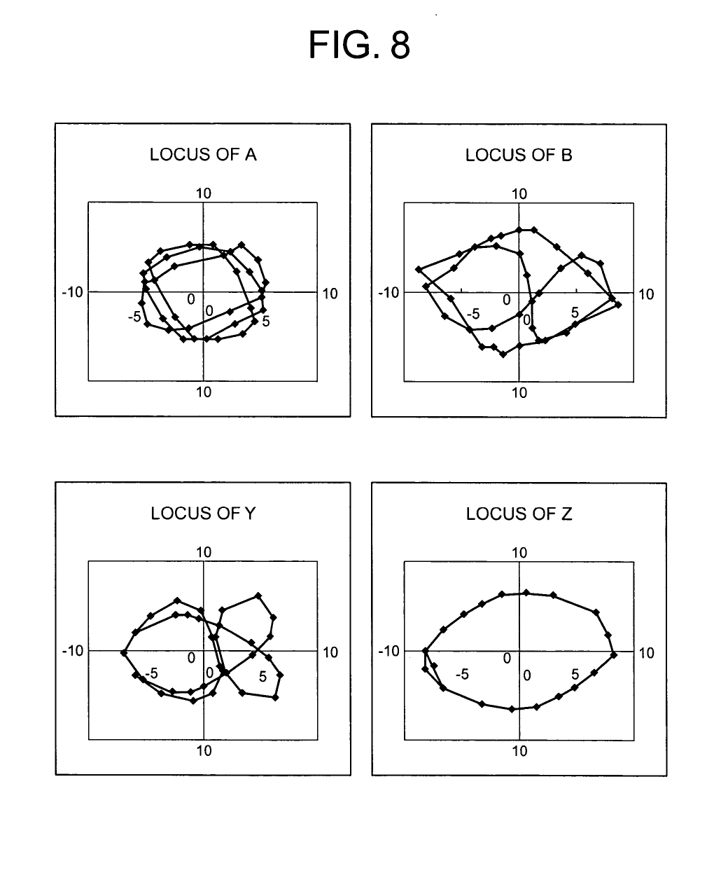

Projection to two-dimensional Eigen (sub) space is carried out for the convenience of putting the drawings on paper. FIG. 8 shows an example of a polygonal line (not smooth) locus for 36 learning samples projected in two-dimensional Eigen (sub) space for four categories. Namely, character “A”, “B”, “Y” and “Z” are shown. These loci have characteristic shapes in all of the categories, and can be discerned to have shapes that cannot be estimated from the shapes of the characters themselves. Further, it can be discerned that characteristics of the characters appear sufficiently even for two-dimensions. The candidate selection unit 28 is therefore also capable of projecting each of a plurality of rotated character images in Eigen space of dimensions (up to dimension) that are meaningful with respect to character recognition for actual character recognition processing.

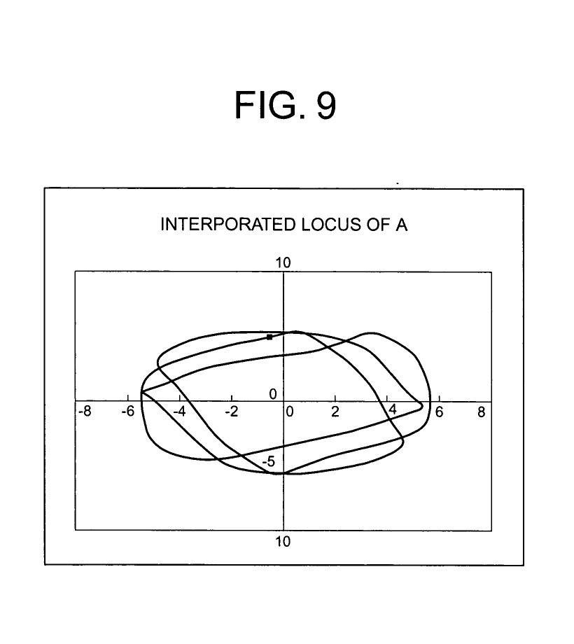

The distance from the projection point X to the locus Lₙ^{(k)} is calculated as follows. Firstly, for the locus Lₙ^{(k)}, for example, 1000 points are interpolated for projection points for the 36 learning samples (sample projection points) using well-known interpolation techniques such as, for example, periodic splines. In this way, a smooth locus Lₙ^{(k)} can be obtained. The angle of each projection point X is calculated from equation (4) described above. FIG. 9 shows an example of a locus Lₙ^{(k)} interpolated by a periodic spline. Second, in reality, a table storing each of the 1000 interpolated points (interpolation points) and coordinates and angles for each sample projection point (plurality of projection points obtained by the image projecting unit 24) is made, and distances from the projection points X to the locus Lₙ^{(k)} are calculated using this table. For example, Lagrange's interpolation may be used as the well-known interpolation technique.

On the other hand, test patterns where the characters are rotated every three degrees may be used in a test for unknown characters (or recognition target characters) so that learning samples do not have to be included. Namely, capital letters (namely, the same as the previous font) for the Century font rotated by 3, . . . , 357 degrees may be used as the test pattern. This then means that 108 test samples (excluding samples that are the same as learning samples from the 120 samples) are tested for each category, so that 2808 (=108×26) samples are used for all of the categories.

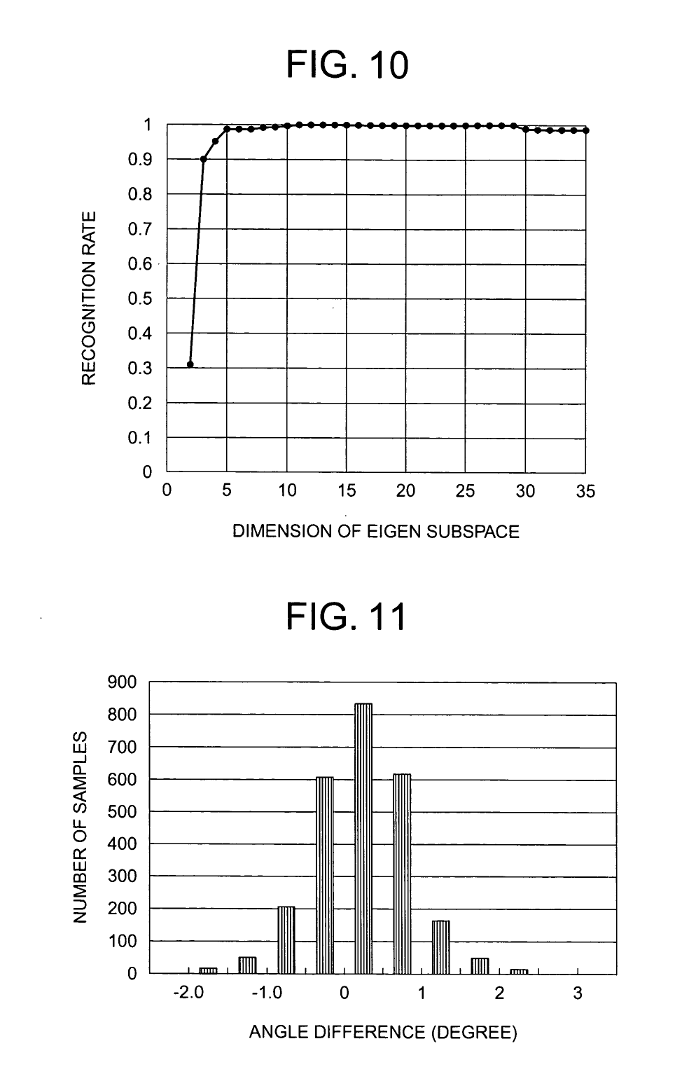

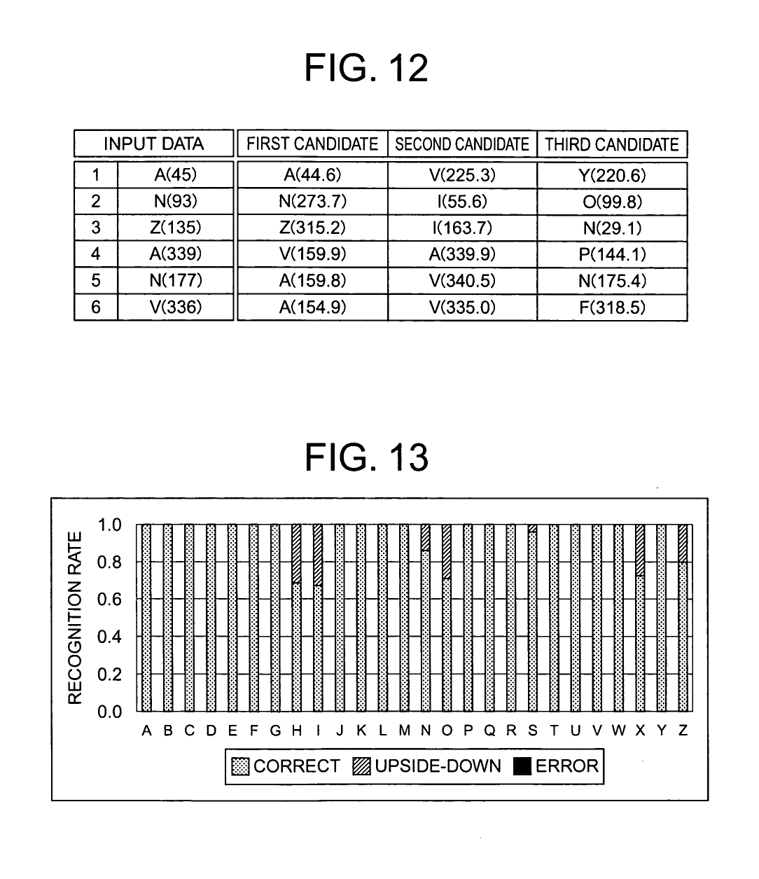

FIG. 10 is a graph of character recognition rate with respect to the number of dimensions of Eigen (sub) space. Up to four dimensions, it can be seen that the character recognition rate is already 90% or more. A maximum recognition rate of 99.89% (with three samples failing) is obtained for Eigen (sub) space of thirteen dimensions. The reason for the erroneous recognition of these three samples may be considered as being because the number of learning samples is partially insufficient or because rotation of ten degrees at a time is not appropriate. In the latter case, it may be considered that rotation at heterogeneous angles will probably be effective or that rotation of ten degrees or less is probably effective. However, the distances between the first to third candidates taken as recognition target characters is extremely small for all of the three erroneously recognized three samples. For example, with a sample 5 (N(177): an image of rotated character “N” rotated by 177 degrees, hereinafter the same) in FIG. 12 described later, the distance for the first candidate (erroneous recognition) is 3.422, and the third candidate (correct) is 3.449.

In the present invention, not just the category for the inputted character image, but also the rotated angle, can be obtained. FIG. 11 shows the evaluation of angle estimation. In FIG. 11, the horizontal axis shows the error in rotation angle (difference between correct angle and recognized angle), and the vertical axis shows the number of samples corresponding to the errors. With characters of symmetrical shapes, samples recognized as being rotated by 90 degrees or rotated by 180 degrees are removed from the evaluation targets. It can be understood from the graph shown in FIG. 11 that substantially all of the rotation angles for the test samples are accurately estimated.

Next, several specific samples are shown. FIG. 12 shows from the upper order first candidate to the third candidate obtained from results for character recognition of the present invention for six patterns. The first three samples (input data #1, #2, #3) are correctly recognized, and the next three samples (input data #4, #5, #6) are erroneously recognized. The number within the brackets expresses the angle. It can be understood from FIG. 12 that correct categories (character types) are present within the upper order three candidates even for erroneously recognized samples.

FIG. 13 shows character recognition rate for each category. Symmetrical patterns are present within the characters of the alphabet. For example, when the characters “H”, “I”, “N”, “0”, “S”, “X” and “Z” are rotated by 180 degrees, they are substantially the same shape. For example, take the samples #2 and #3 of input data of FIG. 12. In the graph in FIG. 13, the regions (correct) shown by “hatching” show the proportion of correct categories and correct angles of rotation obtained. The region (upside-down) shown by oblique lines show the proportion where a correct category is obtained but an erroneous angle of rotation (approximately 180 degree difference) is obtained. Therefore, from FIG. 13, the characters “H”, “I”, “O”, and “X” etc. are originally symmetrical shapes, and recognition for rotation through 180 degrees can therefore be estimated. Regions where the proportion (error) of correct categories or correct rotation angles cannot be obtained are substantially non-existent.

### EXAMPLE 2

Character recognition processing is carried out using the same fonts as for the first embodiment (26 capital letters of the alphabet in the Century font) as the characters that are the target of registration (category), with character recognition processing being carried out by changing the size of the characters. In this way, changes in the size of the characters are seen to influence the character recognition rate.

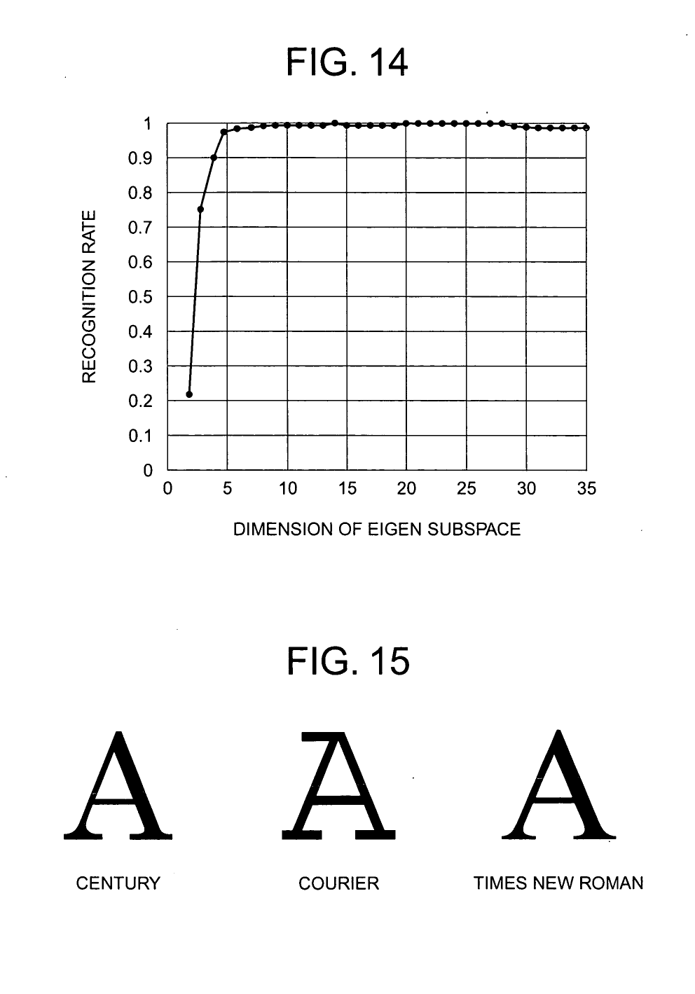

Namely, character patterns of a size of 16 pixels×16 pixels are made for each category, and as with the first embodiment, character recognition processing of the present invention is carried out. In this case, there are 256 (=16×16) characteristic dimensions. FIG. 14 shows character recognition rate for each dimension in Eigen (sub) space. It can be understood from FIG. 14 through comparison with the case for 32×32 pixels that character recognition rate falls by the order of 1%. The character recognition rate for 13 dimensions is 99.07%. Further, a maximum recognition rate of 99.15% (with twenty-four samples failing) is obtained for Eigen (sub) space of fourteen dimensions.

### EXAMPLE 3

Character recognition processing is carried out by changing the input character font type using the character type (category) that is the same as the first embodiment and the loci made in the first embodiment. In this way, changes in the type of font are seen to influence the character recognition rate.

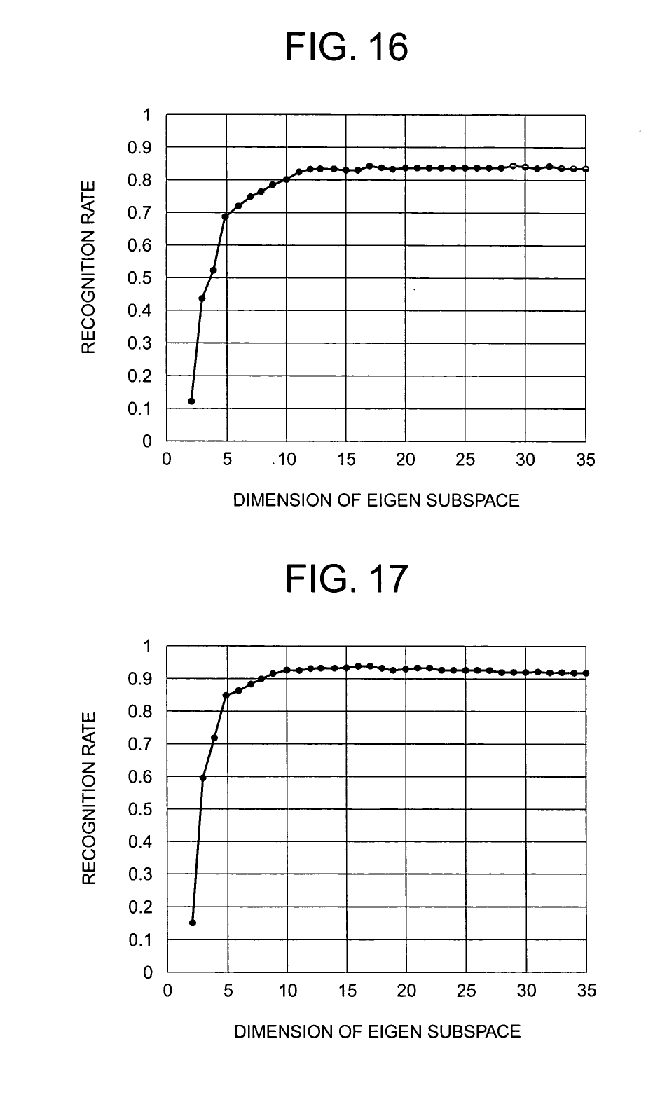

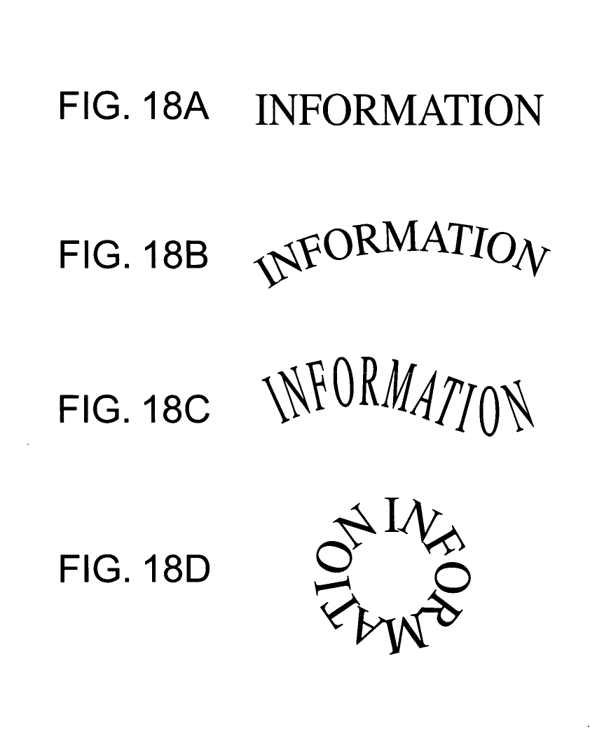

Namely, the Eigen (sub) space made in the first embodiment is used for each category. Character recognition processing of the present invention is then carried out taking the two types of font of the Courier font and the Times New Roman font shown in FIG. 15 as recognition target fonts. The Century font is shown as a reference in FIG. 15. As with the first embodiment, a total of 2808 (=108×26) samples for all categories for 108 test samples per category (samples with angles of rotation corresponding to learning samples are excluded) are subjected to character recognition processing. FIG. 16 shows character recognition rate with respect to dimensions of Eigen (sub) space in the case of the Courier font, and FIG. 17 shows character recognition rate with respect to dimensions of Eigen (sub) space in the case of the Times New Roman Font.

As is understood from FIG. 16, in the case of the Courier font, the recognition rate is 83.40% at thirteen dimensions, and the maximum recognition rate is 84.33% (440 samples failed) at the seventeen dimensional Eigen (sub) space. As is understood from FIG. 17, in the case of the Times New Roman font, the recognition rate is 93.663% at thirteen dimensions, and the maximum recognition rate is 93.95% (170 samples failed) at the sixteen dimensional Eigen (sub) space. It can be considered that a high character recognition rate is obtained compared with the Courier font because the Times New Roman font is similar to the Century font.

As described above, when an Eigen (sub) space is made using the Century font, the results with respect to the same Century font show extremely high character recognition rate and precise character angle. There was also little significant falling between the character recognition rates in the case of normalizing to 32×32 pixels and the case of normalizing 16 pixels×16 pixels. Further, the character recognition rate falls when the font types are different but an accuracy rate of a certain level is obtained.

In the above, a description is given according to the preferred embodiments of the present invention but various modifications are possible whilst remaining within the range of the spirit of the invention.

For example, recognition target characters (character types) are by no means limited to the alphabet, and may also include hiragana, katakana, kanji and other types of language characters, numerals and symbols. Further the recognition target characters (character types) may also include different fonts for the same types of character. Moreover, it is possible to obtain a high recognition rate for a plurality of fonts by using mean character images for the characters for a plurality of fonts as learning characters.

As described above, according to the present invention, with character recognition apparatus and method, by recognizing rotated characters by applying Eigen space techniques, it is possible to obtain extremely high recognition results that satisfy an extremely broad range to a practical extent without there being lowering of character recognition precision even in cases where an angle of inclination of a read character does not match with an angle of inclination of a character registered in a dictionary or in cases where the lining up of read characters is irregular.

Moreover, according to the present invention, the character recognition apparatus and method described above can easily be implemented by providing a character recognition apparatus program stored on a medium such as a flexible disc, CD-ROM, CD-R/W, or DVD etc.

1. A character recognition apparatus comprising:
space storage to store, for a plurality of types of characters, Eigen spaces made from a plurality of rotated character images obtained by rotating first character images for the character types through a plurality of angles;
loci storage to store loci drawn for projection points obtained by projecting the plurality of rotated character images in the corresponding Eigen spaces for the plurality of character types;
an input unit to input images for recognition target characters;
a distance calculation unit to obtain distances for between projection points for the recognition target characters obtained by projecting images for the recognition target characters in Eigen space and each loci for the plurality of character types; and
a candidate selection unit to select candidates for images for the recognition target characters from the plurality of character types.

2. The character recognition apparatus according to claim 1, wherein the candidate selection unit selects only the candidate for which the calculated distance is shortest and decides upon this as the character type of the recognition target character.

3. The character recognition apparatus according to claim 1, wherein the candidate selection unit decides the angles of rotation of the recognition target characters.

4. The character recognition apparatus according to claim 3, wherein the candidate selection unit decides angles of rotation of the recognition target characters through prescribed calculations using projection points of the recognition target characters and the two neighboring points on a locus.

5. The character recognition apparatus according to claim 1, wherein the candidate selection unit projects each of the plurality of rotated character images in Eigen space of a number of dimensions sufficient to be meaningful with respect to character recognition.

6. The character recognition apparatus according to claim 1, further comprising:
image storage to store, for the plurality of character types, a plurality of rotated character images obtained by rotating one character image for a character type through a plurality of angles;
a space producing unit to produce the Eigen spaces for the plurality of character types from the plurality of rotated character images stored in the image storage and storing the spaces in the space storage; and
an image projecting unit to obtain loci from a plurality of projection points obtained by projecting the plurality of rotated character images stored in the image storage in the Eigen spaces corresponding to the plurality of rotated character images stored in the space storage and storing the loci in the loci storage for the plurality of character types.

7. The character recognition apparatus according to claim 6, further comprising:
a locus interpolation unit to obtain interpolation points interpolated from the plurality of projection points obtained by the image projecting unit using prescribed processing for the plurality of character types,
wherein the image projecting unit stores the loci contained in the interpolation points obtained by the locus interpolation unit in the loci storage for the plurality of character types.

8. The character recognition apparatus according to claim 7, wherein the locus interpolation unit carries out spline interpolation to interpolate the plurality of projection points obtained by the image projecting unit using periodic splines.

9. The character recognition apparatus according to claim 7, wherein the locus interpolation unit has a table to store coordinates and angles for the plurality of projection points obtained by the image projecting unit and for interpolation points obtained by the locus interpolation unit, and obtains the distances and angles of rotation for the recognition target characters using the table.

10. The character recognition apparatus according to claim 1, further comprising:
a candidate comparison unit to compare candidates selected by the candidate selection unit and deciding character types for the recognition target characters.

11. The character recognition apparatus according to claim 10, wherein the candidate comparison unit obtains a plurality of rotated character images by rotating the recognition target characters through prescribed angles, obtains a plurality of projection points by projecting the plurality of rotated character images in Eigen spaces corresponding to the candidates selected by the candidate selection unit, and takes the candidate of the candidates selected by the candidate selection unit closest to the plurality of projection points as the character type of the recognition target character.

12. A character recognition method comprising:
preparing, for a plurality of types of characters, Eigen spaces made from a plurality of rotated character images obtained by rotating first character images for the character types through a plurality of angles;
preparing loci drawn for projection points obtained by projecting the plurality of rotated character images in the corresponding Eigen spaces for the plurality of character types;
inputting images for recognition target characters;
obtaining distances for between projection points for the recognition target characters obtained by projecting images for the recognition target characters in Eigen space and each loci for the plurality of character types; and
selecting candidates for images for the recognition target characters from the plurality of character types.

13. A character recognition program for implementing a character recognition method for a character recognition apparatus on a computer, wherein the program causes the computer to execute:
preparing, for a plurality of types of characters, Eigen spaces made from a plurality of rotated character images obtained by rotating first character images for the character types through a plurality of angles, and loci drawn for projection points obtained by projecting the plurality of rotated character images in the corresponding Eigen spaces;
inputting images for recognition target characters;
obtaining distances for between projection points for the recognition target characters obtained by projecting images for the recognition target characters in Eigen space and each loci for the plurality of character types; and
selecting candidates for images for the recognition target characters from the plurality of character types.
